(19) United States
(12) Patent Application Publication
(10) Pub. No.: US 2007/0288326 A1
(43) Pub. Date: Dec. 13, 2007

(54) Billing method and system with preauthorization feature

(76) Inventor: Anthony Boldin, Milwaukee, WI (US)

Correspondence Address: BOYLE FREDRICKSON S.C., 840 North Plankinton Avenue, MILWAUKEE, WI, 53203, US

(21) Appl. No.: 11/450,164

(22) Filed: Jun. 9, 2006

(51) Int. Cl. G06Q 30/00

(52) U.S. Cl. 705/26

(57) ABSTRACT

A method and system of billing consumers includes preauthorizing a purchase with a consumer's credit card and using the preauthorization as collateral against receipt of an alternate form of payment. In this way the retailer is allowed to extend credit to a consumer without assuming the risk of non-payment or the costs associated with determining the creditworthiness of a consumer. The retailer also reduces the processing costs associated with using credit cards by encouraging other forms of payment that typically cost less in terms of processing. In the event the consumer does utilize an alternate form of payment, the retailer is authorized to charge the consumer's credit card for the purchase plus a percentage of the purchase price. The retailer thus recoups the cost associated with accepting credit card payments.

### BACKGROUND OF THE INVENTION

1. Field of the Invention

The present invention relates to a billing method and system, and more particularly, relates to such a method and system having a preauthorization feature.

2. Discussion of the Related Art

In a retail setting, a consumer can pay for goods and services in a number of different ways. For example, if the product is in stock, the consumer can pay in cash and take the product home immediately. The consumer in such a situation can also pay with a check or a credit card, or can be billed for the product at a later date.

In an online retail environment, in which cash transactions are impossible, the consumer can send in a check, can pay immediately with a credit card, or can be billed for the product at a later date. Billing a consumer involves risk for the retailer, since there is no simple way for the retailer to collect payment in the event the consumer fails to pay his or her invoice.

Use of a credit card has both advantages and disadvantages. On the one hand, a retailer can be assured of payment for the goods or services being sold when a credit card is charged, since the credit card can be processed immediately at the time of sale. The credit card will be approved if the credit card company is willing to extend credit to the holder; the card will be declined if the credit card company is not willing to extend credit, such as when a consumer has reached his or her credit limit or is in arrears with his or her payments. When the credit card company approves the amount of the sale, the card company forwards payment to the retailer and in turn accepts responsibility for obtaining payment from the consumer.

However, credit card companies typically charge the retailers between 2 and 4 percent of the purchase price to advance payment for a consumer. The retailer thus pays for the credit card company's assumption of risk in processing costs. Smaller retailers, especially internet retailers, would prefer to avoid the processing costs involved in credit card payment, but do not have the ability to extend credit to unknown consumers. It would be advantageous to such retailers to be able to avoid paying credit card processing costs without assuming the risk of non-payment by consumers.

### SUMMARY OF THE INVENTION

The method and system of the present invention solves the problem of securing payment from a consumer without incurring costs associated with a conventional credit card payment. The method and system take advantage of a preauthorization feature offered by most credit card companies, which allows retailers to preauthorize a charge and then actually post the charge anytime within a certain period, typically 30 days, following the preauthorization. The method of the present invention thus allows a consumer to place an order and collects the consumer's credit card information. The retailer submits the credit card information for preauthorization, but not for payment, and refuses to process orders for consumers whose credit card is not approved. Ideally, the retailer submits a percentage over the order amount in order to cover the credit card processing costs.

However, for consumers whose credit card is approved, the credit card is not billed. Instead, the consumer is sent an invoice, or a series of invoices, over a given time period. Since credit card companies typically allow a 30 day period between authorization of a charge and the charge itself, the consumer can be given those days as a payment period. During the payment period, the consumer may send in a check or direct an automated clearing house (ACH) payment from his or her bank account.

If the consumer does not pay during the payment period, the credit card is charged for the amount of the order, and may additionally be charged a percentage over the amount of the order, although such is not required. In this way the retailer is allowed to extend credit to a consumer without assuming the risk of non-payment and the costs of evaluating the creditworthiness of the consumer. The retailer reduces the processing costs associated with using credit cards by encouraging other forms of payment that typically cost less in terms of processing and, in the event the consumer does not pay by check or electronic transfer in the allotted time period, the retailer is authorized to charge the consumer's credit card for the amount of the purchase plus a percentage over the purchase price, which covers the retailer's cost for credit card payment.

### BRIEF DESCRIPTION OF THE DRAWINGS

Preferred exemplary embodiments of the invention are illustrated in the accompanying drawings, in which like reference numerals represent like parts throughout, and in which:

FIG. 1 is a flow chart illustrating one preferred embodiment of the method of the invention.

### DETAILED DESCRIPTION OF THE PREFERRED EMBODIMENTS

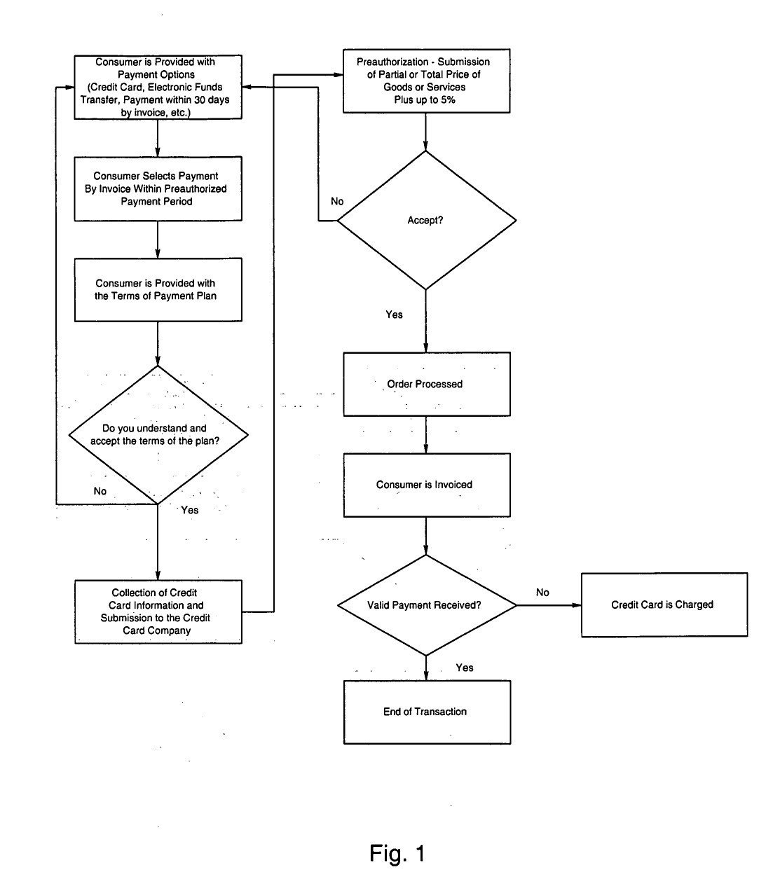

In one preferred embodiment of the method of the invention, illustrated in FIG. 1, a consumer is ready to purchase goods from a retailer. As seen in step 20, the consumer is provided with his or her payment options. These include credit card payment, payment by electronic funds transfer, and payment by invoice within the preauthorized payment period, among other possibilities. Although 30 days is a typical maximum number of days that credit card companies will extend preauthorization, the maximum need not be selected by the retailer, who may, for example, wish to extend a payment period of only 15 days or 20 days. The term “preauthorized payment period” shall therefore refer to whatever number of days is selected by the retailer. If a consumer in step 22 chooses payment by invoice within the preauthorized payment period, at step 24 he or she is provided with the terms of that payment plan, and must assert that he or she understands and accept those terms before checkout can continue at step 26.

If the consumer accepts the terms, his or her credit card information will be collected at step 28 and submitted to the credit card company for preauthorization at step 30. In a preferred embodiment of the invention, the price of the goods or services purchased plus up to 5%, but preferably in the range of 2-3%, over that price are submitted for preauthorization.

At step 32, the credit card company either preauthorizes the total submitted (accept) or does not (decline). If accepted, the order is processed at step 34. If declined, the consumer is returned to step 20, where he or she may choose another option, including another credit card.

In another embodiment of the invention, the retailer does not submit the total price for preauthorization, but only submits a portion of the total. For example, when an order is placed by a known customer, a portion of the total is submitted for preauthorization prior to shipping so that the customer's payment capability can be established. In another example of this embodiment, when a large order is placed, such as when a business entity makes a purchase, only a portion of the total price may be submitted for credit card preauthorization. In this way, the retailer is able to preauthorize at least a down payment amount against an invoice before shipping, thus balancing the risk for potential non-payment, without requiring the total purchase price to be preauthorized.

After the order is processed, in step 36 the consumer is invoiced. Any number of acceptable options are available for the timing of the invoice. For example, in an online retail transaction, an invoice could be sent within a certain period of time from shipping, e.g. three days. The invoice could be sent via e-mail or regular mail and could include information on how the consumer can direct an ACH payment. Alternately, the invoice could follow step 34 more immediately, such as by provision of a page requesting that the customer schedule his or her ACH payment now. It should be noted that the present invention is not limited to use in online retail transactions, and that in a traditional retail environment, in which the product is carried away with the customer, different invoice options, presented in a different order, may be desirable for the consumer and the retailer. The invention should therefore be construed to include all manners of variations in how and when the invoice is delivered to the customer.

Regardless of how and when the invoice is delivered, the invoice contains a payment deadline, which is determined by the payment period selected by the retailer or, if the maximum payment period is selected, the maximum time period of the preauthorization, usually 30 days. The payment deadline reflected in the invoice is the date by which the consumer must pay by check or ACH payment, and is preferably slightly earlier than the date on which the credit card preauthorization expires. Additional invoices could be sent periodically throughout the payment period, such as weekly, until the invoice is paid.

At step 38, the consumer pays the invoice with a check or by providing ACH information. In a preferred embodiment, the invoice is sent by e-mail, and the e-mail contains a link to a webpage that allows space for the consumer to fill in his or her bank information to direct or schedule an ACH payment. If ACH information is provided, the transaction is preferably completed by the retailer so that payment is received by the retailer before the payment deadline. If the consumer pays by check, the retailer completes the transaction so as to ensure payment is received by the retailer on or before the payment deadline. In either case, in the event the ACH payment cannot be completed or the check does not clear (i.e. there are not enough funds in the consumer's selected account), the payment is processed in sufficient time so that the consumer's credit card can still be charged prior to expiration of the preauthorization period.

As shown in step 40, if no payment is received, or if the check or ACH payment fails for lack of funds during the payment period, the credit card is charged for the amount of the purchase plus, typically, a percentage of the purchase price over that amount. The consumer is then sent a receipt via e-mail or letter advising him or her that the card has been charged and that the balance is no longer due.

In one alternative embodiment, if payment is not received by the designated payment deadline prior to expiration of the preauthorization period, the credit card may be re-preauthorized to give the consumer an additional period of time, e.g. 30 more days, within which to complete payment by check or ACH transaction. The payment period is thus extended for another preauthorization period, e.g. to 60 days.

Various other alternatives are contemplated as being within the scope of the following claims.

I claim:

1. A billing method comprising:
allowing a consumer to place an order;
collecting the consumer's credit card information;
submitting the credit card information for authorization;
allowing the order to go forward only if the credit card is approved;
providing at least one invoice to the consumer;
waiting a pre-determined time period to allow the consumer to pay the invoice; and
if the consumer does not pay the invoice within the pre-determined time period, charging the credit card for the amount of the order.

2. The method of claim 1, wherein the step of submitting the credit card information includes submitting a pre-determined amount over the order amount.

3. The method of claim 1, wherein the step of providing at least one invoice to the consumer includes sending the invoice by e-mail.

4. The method of claim 1, wherein the step of providing at least one invoice to the consumer includes sending weekly reminders.

5. The method of claim 1, wherein the step of providing at least one invoice to the consumer includes providing information on scheduling an automated clearing house payment.

6. A billing method comprising:
collecting information for a first form of payment as collateral in a purchase; and
requesting a second form of payment.

7. The billing method of claim 6, further comprising charging a predetermined percentage of the purchase price for use of the first form of payment.

8. The method of claim 6, further comprising the step of providing at least one invoice to the consumer.

9. The method of claim 8, wherein the step of providing at least one invoice to the consumer includes sending the invoice by e-mail.

10. The method of claim 8, wherein the step of providing at least one invoice to the consumer includes sending weekly reminders.

11. The method of claim 8, wherein the step of providing at least one invoice to the consumer includes providing information on scheduling an automated clearing house payment.

12. A payment transaction method, comprising the steps of:
receiving an order from a customer involving a monetary amount;
obtaining credit authorization for payment of at least a portion of the monetary amount from a credit institution affiliated with the customer as collateral without obtaining the payment from the credit institution;
issuing an invoice for the monetary amount having a deadline; and
obtaining payment of at least the portion of the monetary amount from the credit institution in the event the invoice is not paid prior to the deadline.

13. The transaction method of claim 12, wherein the steps of obtaining credit authorization and obtaining payment from the credit institution are carried out such that the amount of the payment from the credit institution exceeds the monetary amount of the order by an amount that corresponds to a processing fee for a credit transaction from the credit institution.

14. The transaction method of claim 12, wherein the step of issuing an invoice is carried out in a way that makes it easy for a customer to direct that the monetary amount be withdrawn from the customer's bank account.

15. The transaction method of claim 14, wherein the step of issuing an invoice is done by e-mail and a link is provided in the e-mail for the customer to provide bank account information.

16. The transaction method of claim 12, further comprising the step of issuing at least one reminder invoice prior to the deadline.

17. A system for use with a payment transaction method, the system comprising:
a means for receiving an order from a customer involving a monetary amount;
a means for obtaining credit authorization for payment of the monetary amount from a credit institution affiliated with the customer as collateral without obtaining the payment from the credit institution;
a means for issuing an invoice for the monetary amount having a deadline; and
a means for obtaining payment of the monetary amount from the credit institution in the event the invoice is not paid prior to the deadline.

18. The system of claim 17, further comprising a means for obtaining payment from the credit institution in excess of the monetary amount of the order by an amount that corresponds to a processing fee for a credit transaction from the credit institution.

19. The system of claim 17, further comprising a means for withdrawing a monetary amount from the customer's bank account.

20. The system of claim 17, further comprising a means for issuing at least one reminder invoice prior to the deadline.
